(19) United States
(12) Patent Application Publication
(10) Pub. No.: US 2026/0159915 A1
(43) Pub. Date: Jun. 11, 2026

(54) METHOD OF EXTRACTING LITHIUM FROM LOW-CLAY MINERALS

(71) Applicant: Instituto Mexicano del Petróleo, Mexico City (MX)

(72) Inventors: Fernando Álvarez Ramírez, Mexico City (MX); Marco Antonio Osorio Bonilla, Mexico City (MX); Luis Manuel Quej Ake, Mexico City (MX); Joel Reza González, Mexico City (MX); Perla Morales Gil, Mexico City (MX); Ricardo Torres Vargas, Mexico City (MX); Gustavo Murillo Muñetón, Mexico City (MX); J. Ascensión Montoya De La Fuente, Mexico City (MX); Joel Ramírez Salgado, Mexico City (MX); José Antonio Toledo Antonio, Mexico City (MX); Jaime Sánchez Valente, Mexico City (MX); Renato Castro Govea, Mexico City (MX); Elsa Carolina Velarde Figueroa, Mexico City (MX)

(21) Appl. No.: 19/181,829

(22) Filed: Apr. 17, 2025

(30) Foreign Application Priority Data
Apr. 17, 2024 (MX) MX/A/2024/004695

(51) Int. Cl. C22B 7/00; C22B 1/02; C22B 1/26; C22B 3/12; C22B 26/12

(52) U.S. Cl. CPC C22B 7/008; C22B 1/02; C22B 1/26; C22B 3/12; C22B 26/12

(57) ABSTRACT

The present disclosure discloses a method of extracting lithium from complex clay minerals whose mineral compositions are in the ranges: Orthoclase (20-60%), quartz (4-60%), calcite (4-65%), being clays containing lithium (2-35%). The method can include the following steps: (1) a process of particle reduction and sieving; (2) a process of dry mixing of the sodium sulfate-sifted ore, Na₂SO₄, in a mineral: Na₂SO₄ ratio ranging from 5:1 to 5:3; (3) a roasting process with temperatures between 70° and 900° C., for a period of between 30 and 120 minutes; and (4) two processes of leachate of the calcined ore with additive in water and the collection by filtering the liquor with lithium. Depending on the composition of the clay ore, this process produces yields between 50 and 85% of lithium extraction from the rock to the liquor.

### CROSS-REFERENCE TO RELATED APPLICATIONS

This patent application claims priority under 35 U.S.C. Section 119 to Mexican Patent Application No. MX/a/2024/004695, filed Apr. 17, 2024, the entire disclosure of which is incorporated herein by reference.

### FIELD

The present disclosure relates to a pyro-hydrometallurgical method for extracting lithium from minerals of low lithium concentration, which are found in mineral matrices of variable and complex composition.

### BACKGROUND

Lithium, Li, is a chemical element of great economic, industrial, technological and research interest. It is the third element in the Periodic Table (after hydrogen and helium), the 25th, the most abundant element in the earth's crust (20 mg/kg) and the lightest metal in nature (density=0.534 g/cm³). Like sodium and potassium, lithium is an unstable metal that can experience spontaneous combustion when exposed to air. Due to its high reactivity, lithium only exists in nature, combined with other elements, forming a wide variety of minerals (Brooks K. Lithium Minerals Geology Today, Vol. 36, No. 5, September-October 2020. The Geologists' Association & The Geological Society of London, John Wiley & Sons Ltd.). Lithium can be produced from a variety of natural sources including minerals (such as pegmatites and sedimentary rocks); salt flats (saline lakes) and brines (e.g., those associated with oil and gas production) (Meshram P., Pandey B. D., Mankhand T. R. Extraction of lithium from primary and secondary sources by pre-treatment, leaching and separation: A comprehensive review. Hydrometallurgy Volume 150, Pages 192-208. December 2014).

The main sources of lithium from hard rock minerals (pegmatites) include (1) spodumene (Christmann P., Gloaguen E., Labbé J.-F., Melleton J., Piantone P. Global Lithium Resources and Sustainability Issues. In the book: Lithium Process Chemistry. Resources, Extraction, Batteries, and Recycling, Pages 1-40, Chapter 1, June 2015. Ed. Chagnes A, Swiatowska J.), which is a lithium-rich pink silicate mineral that is the most commercially available source; It is found in pegmatite, an igneous rock. Pure spodumene ideally contains a concentration of 8% wt of lithium oxide (Li₂O) (Brooks K. Lithium Minerals Geology Today, Vol. 36, No. 5, September-October 2020. The Geologists' Association & The Geological Society of London, John Wiley & Sons Ltd.). (2) Petalite, another lithium silicate mineral that is rarer than spodumene. (Karrech A., Azadi M. R., Elchalakani M., Shahin M. A., Seibi A. C. A review on methods for liberating lithium from pegmatities. Minerals Engineering, Vol. 145, pp. 106085, 1 January 2020) (3) Lepidolite, a lithium-containing lilac mica mineral found in pegmatites and granites (Luong V. T., Kang D. J., An J. W., Kim M. J. Tran T. Factors affecting the extraction of lithium from lepidolite”, Hydrometallurgy, Vol 134-135, pp. 54-61, 2013). However, processing pegmatites is expensive compared to processing brines, due to the heating and dissolving stages involved.

On the other hand, brines come mainly from: (1) salt flats of large flat salt flats with concentrated brines containing lithium (Zhang J, Cheng Z., Qin X., Gao X., Wang M., Xiang X. Recent advances in lithium extraction from salt lake brine using coupled and tandem technologies”, Desalination, Vol. 547, pp. 116225, 1 Feb. 2023) (2) geothermal brines, which are hot brines found near geothermal areas (Mends E. A., Chu P. B. Lithium extraction from unconventional aqueous resources-A review on recent technological development for seawater and geothermal brines. Journal of Environmental Chemical Engineering, Vol 11, issue 5, pp. 110710, October 2023), (3) oilfield brines, produced during oil and gas extraction. They may contain trace amounts of lithium, offering potential for co-extraction (Ryabtsev A. D., Kotsupalo N. P., Kurakov A. A., Nemkov N. M., Vakhromeev A. G. Rational Use of Multicomponent Brines Extracted Together with Oil”, Theoretical Foundations of Chemical Engineering. Vol, 54, pp. 756-761, 29 Sep. 2020). Lithium requirements in the future are directly related to the growth on demand for lithium batteries, which are used in a wide range of applications, including electric vehicles, energy storage, and portable electronic devices. This has led to the exploration of new sources to obtain this valuable metal, such as: (1) seawater, which contains small amounts of lithium, where large-scale extraction is technically possible, but not yet commercially viable (Mends E. A., Chu P. B. Lithium extraction from unconventional aqueous resources-A review on recent technological development for seawater and geothermal brines. Journal of Environmental Chemical Engineering, Vol 11, issue 5, pp. 110710, October 2023) and (2) Lithium trapped in sedimentary minerals is also mined in the form of clay minerals such as hectorite. This material is a type of magnesium and lithium-rich smectite that typically contains between 0.3 and 0.6% Li.

Currently, approximately three-quarters of lithium extracted from minerals comes from hard rock deposits, while a quarter of production comes from sedimentary sources (Brooks K. Lithium Minerals Geology Today, Vol. 36, No. 5, September-October 2020. The Geologists' Association & The Geological Society of London, John Wiley & Sons Ltd.). Table 1 shows the average lithium content from different available natural sources (Meshram P., Oandey B. D., Mankhand T. R. Extraction of lithium from primary and secondary sources by pre-treatment, leaching and separation: A comprehensive review. Hydrometallurgy Vol 150, pp. 192-208, December 2014).

Hectorite is a clay mineral formed because of the precipitation of minerals from lake waters or by the capture of lithium ions from pre-existing clay deposits. Most hectorite exploitation is not geared towards lithium recovery but for use in drilling operations in the oil and gas industries. There are several deposits of hectorite in the world, among these the deposits in Sonora, in northern Mexico, are some of the largest. It is important to take into consideration that each deposit has a different mineralogical composition (Table 1) and therefore requires the appropriate technology for its processing. It is precisely in this source of lithium that the interest of the present disclosure is located.

The main challenge of extracting lithium from low-clay minerals is the low concentration of lithium. This makes it difficult for economical extraction of lithium. Another challenge is the complex nature of mineral. Lithium is often bound to other minerals, making it difficult to selectively extract. It is important to note that the specific method used to extract lithium from low-clay minerals will depend on the specific characteristics of the mineral and economic considerations.

Among the methods being developed and researched to extract lithium from low-clay ores are: (1) acidification, this involves treating the mineral with an acid, such as sulfuric acid, to dissolve the lithium. This process is relatively simple and well-established, but it can be costly and generate large amounts of waste. (2) Ion exchange, which involves passing a solution containing lithium ions through a resin that selectively adsorbs lithium. This process can be very selective and efficient, but it can be costly and require large amounts of water. (3) Electrochemical methods, in which electricity is used to extract lithium from ore. (4) Biohydrometallurgy, in which bacteria or fungi are used to extract lithium from the mineral. (5) Finally, there are salt roasting methods in which the mineral is heated with a salt, to convert lithium into chlorides or water-soluble sulfates.

The composition of the ore has a significant impact on the sulfation process. Lithium-rich minerals, such as spodumene and lepidolite, sulfate more easily than minerals with lower lithium concentrations. The presence of other minerals such as quartz and feldspar can also affect the sulfation process. These minerals can act as diluents, making it difficult for the sulfating agent to react with lithium-containing minerals.

In general, the sulfation process is most effective for fine-grained minerals and large surface areas. This is because the sulfating agent has more contact with lithium-containing minerals and can act more effectively. Reaction temperature and pressure can also affect the sulfation process. Higher temperatures and pressures can increase reaction rates, but they can also lead to the formation of unwanted byproducts.

Because research and patents on lithium mining have focused primarily on lithium-rich minerals, such as spodumene, petalite, and lepidolite, there is currently little research and development of patents on low-lithium clays globally, and in particular using sodium sulfate as a sulfating agent to convert lithium into a water-soluble sulfate. Among the main antecedents of application of sodium sulfate as a sulfating agent we can mention the Chinese patent application CN111893318A [1], which protects a method of extracting lithium from lithium-containing clays. This disclosure involves mixing the mineral with additives, such as calcium carbonate, sodium sulfate, and potassium sulfate according to a mass ratio of 5:1:1:1, to which water is added to obtain a paste. The paste is ground to a size P80, 50-100 μm, forming spheres which are placed in an oven to be toasted at a temperature of 900-1100° C. for 1-3 hours.

Another Chinese patent application CN116814986A [2], reports a similar technology of applying salts as sulfating agents, which consists of mixing lithium ore, sodium sulfate, ferric sulfate, and calcium oxide. The mixture is roasted to obtain a roasted material, which is leached to obtain a solution that contains lithium, called liquor. This disclosure protects the mass ratio of the total mass of ferric sulfate, sodium sulfate, and calcium oxide to the mass of lithium ore in the mixture of 0.5-3:1 and 1:0.6-0.8:0.2-0.4. In both proportions the roasting temperature is 700 to 800° C. and the roasting time is 30 to 90 minutes.

The Chinese patent application CN103849761A [3] claims rights to a “modified roast-discharge leaching” process for large clay minerals containing low-grade lithium in the northern Henan region of China. In this method, the mining of low-grade lithium clay is proposed, which is crushed to 2 mm, and then mixed and roasted with calcium sulfate, calcium fluoride (Fluorspan) and sodium sulfate. The mass ratio for lithium clay and additives is: (lithium clay:calcium sulfate:calcium fluoride (Fluorspan):sodium sulfate)=1:0.7:0.2:0.5. The mixed material is placed in an oven at 800° C. for 2 to 3 hours.

The co-extraction of lithium, rubidium and cesium from lepidolite as mineral feedstock including feedstock pretreatment, roasting, mechanical activation processing, leaching, separation and extraction process has been reported in the Chinese patent application CN107475537A [4]. In pre-treatment, lepidolite is mixed with a roasting additive. The roasting additive is made up of the mixture of sodium humate, sodium hydroxide, sodium sulfate, calcium oxide or calcium acetate in a mass ratio of sodium humate, sodium hydroxide, sodium sulfate with respect to calcium compounds of 0.5-1.5:0.2-0.8:1. The mixture is then subjected to mechanical activation and roasting, followed by an autoclave acid leaching process.

### SUMMARY

As discussed in reference to the above references, various technologies are described to play a role in obtaining lithium, however, there is no specific evidence referring to the pyro-hydrometallurgical methodology of the present disclosure for the extraction of lithium from clay minerals located in Mexico low in clay with low lithium concentration, where the mineral matrices are of variable and complex composition, which makes selective extraction difficult.

Therefore, an objective of the present disclosure is to provide an efficient method of extracting lithium from low-lying minerals in clays of complex mineralogical composition.

Another objective is to obtain high yields in lithium extraction, regardless of the composition of the clay minerals, using sodium sulfate as a sulfating agent through a roasting process.

An additional objective will be to obtain a lithium-rich solution through the process of leaching the lithium sulfate contained in the minerals, to simplify the subsequent refining processes.

### BRIEF DESCRIPTION OF THE DRAWINGS

In order to provide clarity in the description of the method of extraction of lithium from low-clay minerals, which is the subject of this disclosure, reference shall be made to the accompanying drawings, without limiting the technical scope:

FIG. 1A and FIG. 1B show the crystalline phases and their concentration in clay minerals located in Mexico that are determined by X-ray diffraction, Rietveld's quantitative method in different geological samples considered for this disclosure. The numbering corresponds to different geological horizons from which the clay mineral samples were collected. Table 2 corresponds to the range of concentrations detected for each of the crystalline phases in the geological horizons analyzed. These horizons in turn were divided into lower and upper units. FIG. 1A shows the lower units of the geological horizon. FIG. 2A shows the upper units of the geological horizon.

FIG. 2A is a graph showing evidence of sulfation of the clay ore after roasting process corresponding to Example 3. The diffraction angle peak around 22° (2θ) and close to 28° (2θ) are assigned to lithium sulfate. Evidence of traces of the additive, sodium sulfate, is clearly observed. FIG. 2B is a graph showing the peaks of the diffraction pattern associated with the pure crystalline phases Li₂SO₄, CaSO₄, MgSO₄, Na₂SO₄ and their correlation with the diffraction standard in Example 3. As a whole, the composite graph of FIGS. 2A and 2B show the association of the peaks of 22° and 28° with the presence of lithium sulfate in the sample in Example 3.

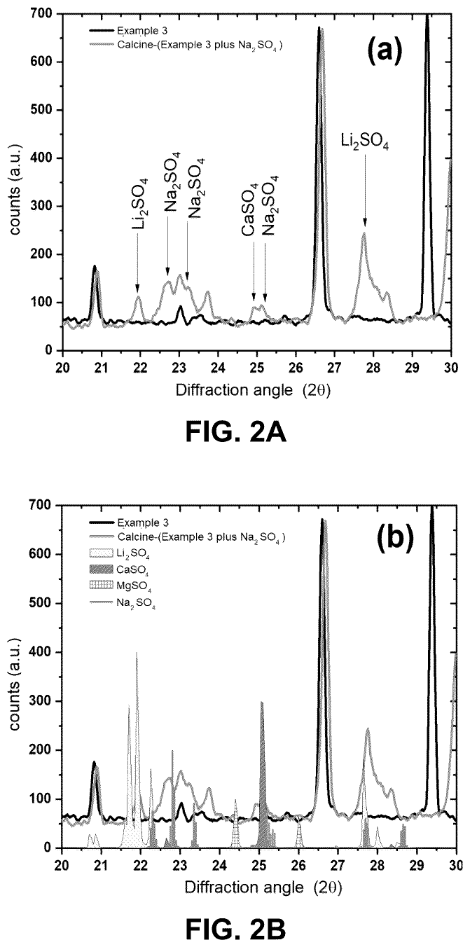

FIG. 3A, FIG. 3B, FIG. 3C, and FIG. 3D show evidence of complexity of the clay mineral matrix in Example 3. The clays, observed as flakes in FIGS. 3A-D are embedded and scattered in the mineral matrix.

### DETAILED DESCRIPTION

The present disclosure comprises a specific methodology for the extraction of lithium from clay minerals located in Mexico with low concentration of lithium, which are found in mineral matrices of variable and complex composition, making their selective extraction difficult. The methodology consists of a roasting procedure with sodium sulfate salts, Na₂SO₄, in a mineral ratio: Na₂SO₄ of 5:1-3, which includes the grinding and sieving of the ore, mixed with Na₂SO₄, roasting them until the leachate process is reached. The mineral samples used for the development of this disclosure come from complex deposits, composed mainly of feldspars, quartz and calcite, while the lithium containing clays are mainly made up of polylithionite and hectorite. In addition, other crystalline phases with less presence in the deposit are observed. The very nature of the samples is complex, which was corroborated by scanning electron microscopy studies, indicating a great heterogeneity and cross-linking of the crystal phases. Unlike other methods reported in the literature, the present disclosure uses only sodium sulfate, Na₂SO₄, as the only sulfating agent used in the roasting process, reaching leachate extraction levels of the roasted compounds from 50 to 85%, depending on the composition of the mineral. The characteristics of the methodology used can be adjusted according to the nature of the mineral, optimizing the performance of Na₂SO₄ as a sulfating agent and thus showing a better performance.

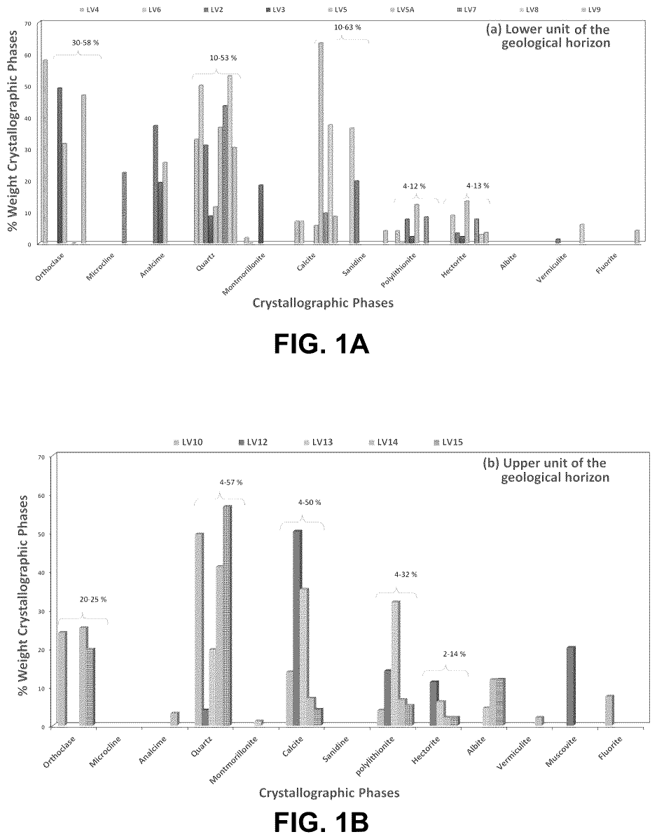

FIGS. 1A and 1B show the crystalline phases and their concentration in clay minerals located in Mexico that are determined by X-ray diffraction, Rietveld's quantitative method in different geological samples considered for this disclosure. The numbering corresponds to different geological horizons from which the clay mineral samples were collected. Table 2 corresponds to the range of concentrations detected for each of the crystalline phases in the geological horizons analyzed. These horizons in turn were divided into lower (FIG. 1A) and upper (FIG. 1B) units.

The methodology of the present disclosure is applicable to complex mineral samples. The composition of the ore has a significant impact on the sulfation process, in general, minerals with lower concentrations of lithium are more difficult to sulfate than lithium-rich minerals. The presence of other minerals such as quartz and feldspar can also affect the sulfation process. These minerals can act as diluents, making it difficult for the sulfating agent to react with lithium-containing minerals.

The X-ray diffraction technique, with Rietveld's refinement, was used for the quantitative determination of phases present in the raw material where this disclosure is applicable. It was found that the material is mainly made up of orthoclase, which can vary between 20 and 60%, quartz, which can vary between 4-60%, and calcite, which can vary between 4-65%. In contrast, most lithium-containing clays consist of 2% to 35% polythionate and 2% to 15% hectorite. In addition, crystalline phases (e.g., <25% microclinite, <40% analcime, <20% mormorillonite, <40% sanidine, <12% albite, <10% vermiculite, and <10% fluorite) may be present. FIGS. 1A and 1B illustrate in greater detail the distribution of crystalline phases in the different geological horizons mentioned above. This disclosure is applicable to minerals with lithium concentrations from 300 to 7000 ppm.

In view of the above, the present disclosure provides a method for extracting lithium from clay minerals with low lithium content comprising:

(1) In one aspect of the present disclosure, the ores undergo a process of reducing their particle size, employing a grinding process by means of a ring mill. The process is carried out efficiently if it is carried out over a period of between 10 and 60 minutes. In some forms of disclosure, the process also involves the pre-pulverization of the ore, by means of a hammer before grinding.

(2) In another aspect of the present disclosure, the minerals subjected to the particle reduction process are screened to obtain an ore with a particle size between 0.074 mm (200 mesh) and 0.149 mm (100 mesh).

(3) In another point, the sieved ore is mixed with sodium sulphate (Na₂SO₄), in a mineral ratio: Na₂SO₄ that varies in the range 5:1 to 5:3.

(4) In another aspect of the present disclosure, the mineral/Na₂SO₄ mixture undergoes a roasting process. Roasting is carried out under conditions of atmospheric pressure and in the presence of air. In some modalities, the roasting temperature varies in the range between 70° and 900° C., for a period of between 30 and 120 minutes.

(5) In another aspect of the present disclosure, the mineral/Na₂SO₄ mixture, roasted and cooled to 25° C., is mixed with water in a water/calcined material ratio ranging from 3:1 to 1:3

(6) In some modalities of the present disclosure, the water/calcined material mixture is left to stand for a period of between 30 and 100 minutes. After this period, the mixture is filtered to obtain a liquid fraction known as leachate fraction 1 and a solid fraction.

(7) In some modalities of the present disclosure, the collected solid fraction is subjected to a second water-washing process using a water-to-solid fraction ratio ranging from 3:1 to 1:3. After this process, a second liquid fraction known as leachate fraction 2 and a solid fraction are obtained.

(8) In another aspect of the present disclosure, the concentration of Li in the treated original ore is quantified (by atomic absorption (AA) spectroscopy or inductively coupled plasma optical emission spectrometry (ICP-OES) in the leachate fraction 1, the leachate fraction 2, as well as in the solid fraction in order to quantify the efficiency of the lithium extraction process present in the original ore.

### EXAMPLES

The following examples are presented to illustrate an efficient methodology for the extraction of lithium from low-clay, low-lithium minerals, which is the subject of this disclosure, and should not be considered as limitations of its technical scope but merely teaches the best way to use it properly.

### Example 1

Grinding was carried out by means of a ring mill from an ore sample. This was sifted to a particle size of 0.077 mm (mesh 200). Subsequently, the ore was mixed with Na₂SO₄. The generated mixture contained 12 g of Na₂SO₄ and 30 g of clay mineral of composition 58.0% orthoclase, 32.9% quartz, 3.3% montmorillonite, 1.8% calcite and 4.0% polylithionite until 42 g was obtained. The concentration of lithium in the original clay ore was 509.7 ppm determined by ICP-OES. The mineral mixture: Na₂SO₄ was mechanically agitated to obtain a uniform distribution of Na₂SO₄ in the clay ore. The mixture was roasted for 2.0 hours at 800° C., recovering 41.15 g of roasted powder, which was cooled and subjected to a grinding and sieving process at 0.077 mm. 82.3 g of water was added to the 41.15 g of the roasted mineral mixture: Na₂SO₄, the mixture was allowed to stand for 30 min after which it is stirred for 30 min and filtered to 71.67 g of leachate 1 of clay ore. A second wash was immediately carried out using 84.6 g of water, obtaining 84.6 g of leachate 2. The extraction yield obtained given this mineral composition was 76.0% (Table 3).

### Example 2

Separately, both clay ore and Na₂SO₄ are ground and sieved into powders with sizes smaller than 0.077 mm (200 mesh). A solid mixture of the sieved powders is made with a content of 12 g of Na₂SO₄ and 30 g of clay ore, which is composed of 24.1% orthoclase, 59.4% quartz, 9.4% calcite and 7.1% hectorite until 42 g is obtained. The concentration of lithium in the clay is 1,639.3 ppm determined by ICP-OES. This mixture is stirred until a uniform distribution of Na₂SO₄ is obtained in the clay ore. It is roasted for 2.0 h at 800° C., obtaining 40.62 g of toasted powder, which is cooled and subjected to light grinding and sieved to 0.077 mm to remove agglomerates. 81.3 g of water is added to the 40.62 g of the toasted mixture, left to stand for 30 min, after which it is stirred for 30 min and filtered until 69.5 g of clay leachate is obtained. A second wash is immediately done with 81.3 g of water, obtaining 80.1 g of clay leachate. The extraction yield obtained given this mineral composition was 59.5% (Table 3).

### Example 3

Separately, both clay ore and Na₂SO₄ are ground and sieved into powders with sizes smaller than 0.077 mm (200 mesh). A solid mixture of the sieved powders is made with a content of 12 g of Na₂SO₄ and 30 g of clay ore which is composed of 32.7% polythithione, 19.7% quartz, 35.6% calcite and 6.2% hectorite until 42 g is obtained. The concentration of lithium in the clay is 4,063.6 ppm determined by ICP-OES. This mixture is stirred until a uniform distribution of Na₂SO₄ is obtained in the clay ore. It is roasted for 2.0 h at 800° C., obtaining 36.69 g of roasted powder, which is cooled and subjected to light grinding and sieving to 0.077 mm to remove agglomerates. 73.23 g of water is added to the 36.69 g of the toasted mixture, left to stand for 30 min, after which it is stirred for 30 min and filtered until 63.0052 g of clay leachate is obtained. A second wash is immediately done with 76.17 g of water, obtaining 76.17 g of clay leachate. The extraction yield obtained given this mineral composition was 81.8% (Table 3).

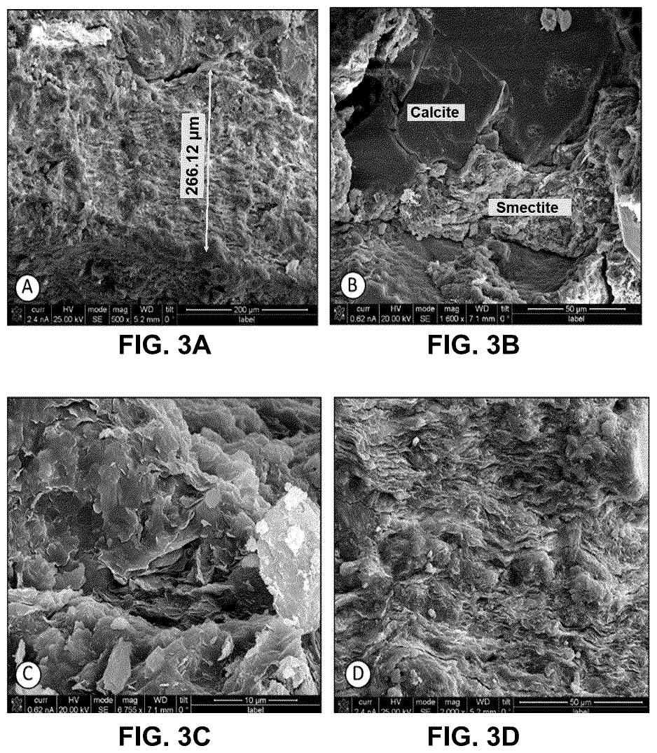

FIGS. 3A-3D show evidence of the complexity of the clay mineral matrix in Example 3. The clays, observed as flakes in FIGS. 3A-3D are embedded and scattered in the mineral matrix.

### Example 4

Separately, both clay ore and Na₂SO₄ are ground and sieved into powders with sizes smaller than 0.077 mm (200 mesh). A solid mixture of the sieved powders is made with a content of 12 g of Na₂SO₄ and 30 g of clay ore which is composed of 16.6% quartz, 4.5% polylithionite, 75.5% montmorillonite, 1.3% hectorite and 2.1% compounds of calcite, iron oxides and silicon oxide until 42 g is obtained. The concentration of lithium in the clay is 3,250.0 ppm determined by ICP-OES. This mixture is stirred until a uniform distribution of Na₂SO₄ is obtained in the clay ore. It is roasted for 2.0 h at 800° C., obtaining 36.69 g of roasted powder, which is cooled and subjected to light grinding and sieving to 0.077 mm to remove agglomerates. 73.26 g of water is added to the 36.63 g of the toasted mixture, left to stand for 30 min, after which it is stirred for 30 min and filtered until 65.40 g of clay leachate is obtained. A second wash is immediately done with 73.26 g of water, obtaining 72.92 g of clay leachate. The extraction yield obtained given this mineral composition was 75.1% (Table 3).

Table 3 shows a summary of the lithium recovery rate using the methodology that is the subject of this disclosure. The results show that the profitability of the method depends on the clay mineral composition. The best extraction yield results correspond to samples with higher lithium content, which can vary between 85% (Example 3) and 75% (Example 4).

As can be seen, unlike other methods reported in the prior art, the present disclosure uses only sodium sulfate, Na₂SO₄, as the only sulfating agent used in the roasting process, reaching levels of extraction by leachate of the roasted compounds from 50 to 85%, depending on the composition of the mineral. Additionally, given the mineralogical complexity of the deposit and the low lithium contents, the methodology achieves high percentages of lithium extraction with a reduced number of unit operations. Finally, the use of sodium sulfate as a sulfating additive offers the advantage of being a chemical product with low economic cost and reduced environmental impact.

TABLE 1
Lithium concentration in various natural sources.

| | Li concentration/% |
|---|---|
| Fountain | (mass/mass) |
| Pegmatite | |
| Spodumene | 1.9-3.3 |
| Lepidolite | 1.53-3.6 |
| Zabuyelita | 17-18.75 |
| Petalite | 1.6-2.1 |
| Amblygonite | 3.5-4.2 |
| Eucryptite | 2.34 |
| Secondary Resource | |
| Spent lithium-ion | 2-7 |
| batteries | |
| Sedimentary rocks | |
| Smectite (hectorite) | 0.27-0.7 |
| Lakeside evaporites | 1.8% as Li₂O |
| Brine | |
| Continental | 530-2700 mg/L (con K, B) |
| Geothermal | <400 mg/L (con Mn y Zn) |
| Oil Field | <700 mg/L (con Br) |
| Seawater | 0.18 mg/L |

TABLE 2
Crystalline phases identified and quantified in the lower
and upper unit of the geological horizon. The data shown
in this table are shown graphically in FIGS. 1A-1B.

| | Range of concentrations in upper |
|---|---|
| Crystalline phases | and lower units % weight |
| Orthoclase | 20-60 |
| Quartz | 4-60 |
| Calcite | 4-65 |
| Polylithonite | 4-35 |
| Hectorita | 2-15 |

TABLE 3
Li extraction yield in the different clay ore samples selected.

| | | | | Leached 1 | | Leachate 2 | | Lithium | |
|---|---|---|---|---|---|---|---|---|---|
| | Mineral | Mineral | Mineral | | Li in | | Li in | in | |
| | Weight/ | Yield/ | Intake/ | Weight/ | Leached/ | Weight/ | Leached/ | liquids/ | Yield/ |
| Number | g | ppm | mg | g | ppm | g | ppm | mg | % |
| Example 1 | 30 | 509.7 | 15.3 | 71.7 | 130.9 | 84.6 | 26.5 | 11.6 | 76.0 |
| Example 2 | 30 | 1639.3 | 49.2 | 69.5 | 328.9 | 80.1 | 79.9 | 29.3 | 59.5 |
| Example 3 | 30 | 4063.6 | 120.6 | 63.0 | 1013.2 | 76.2 | 457.7 | 98.7 | 81.8 |
| Example 4 | 30 | 3250 | 97.5 | 65.4 | 735.5 | 72.9 | 344.3 | 73.2 | 75.1 |

### REFERENCES CITED

Citations of the references discussed herein are provided below:
[1] X. Fu, G. Gao, F. Zhou, Z. Zhu, C. Xiao, H. Liao, L. Lin, R. Chen, W. He, J. Li, P. Qian, B. Yang (2020) Method for extracting lithium from lithium-containing clay (chinese patent application, number CN111893318A).
[2] F. Wu, B. Yu, Q. Long, C. Wu, W. Wu, A. Luo (2023) Method for recovering lithium from lithium ore and application thereof clay (chinese patent application, number CN116814986A).
[3] Z. Gao, X. Song, J. Xu, R. Li, Z. Li, C. Li, X. Zhou, H. Sun, Y. Feng, B. Geng, Z. Yan (2014) Method for extracting lithium from low-grade lithium-containing clay ore (chinese patent application, number CN103849761A).
[4] J. Nan, H. Li, J. Wu (2017) Lithium, rubidium, the method for cesium salt are extracted from lepidolite raw material ore (chinese patent application, number CN107475537A).

What is claimed is:

1. A pyro-hydrometallurgical method for extracting lithium from complex clay minerals whose lithium-containing mineral compositions are in the ranges: orthoclase between 20 and 60%, quartz between 4 and 60%, calcite between 4 and 65%, clays between 2 and 35%, wherein the method comprises:
(a) reducing the particle size with a ring mill for a period of between 10 and 60 minutes;
(b) sieving the pulverized ore to a particle size between 0.074 and 0.149 mm;
(c) dry-mixing the sodium sulphate-sifted ore, Na₂SO₄, in a mineral/Na₂SO₄ ratio ranging from 5:1 to 5:3;
(d) roasting the mineral/Na₂SO₄ mixture under atmospheric pressure and in the presence of air at a temperature in the range of 700 to 900° C. for a period of 30 to 120 minutes;
(e) cooling the mineral/Na₂SO₄ mixture to 25° C., and then mix with water in a water-to-calcined material ratio between 3:1 and 1:3;
(f) leaving the calcined water/mineral mixture to rest for a period of between 30 and 100 minutes;
(g) filtering the mixture of step 1 (f) to separate a leachate fraction and a solid fraction;
(h) subjecting the first collected solid fraction to a second leaching with water in a water/solid fraction ratio ranging from 3:1 to 1:3;
(i) obtaining a second liquid and solid fraction of the leaching; and
(j) collecting the solutions of the first and second leaching, thereby obtaining a liquor rich in lithium in a content ranging from 100 to 7000 ppm.

2. The method according to claim 1, wherein the method processes crystalline phases in the ore of <25% microclinite, <40% analcime, <20% mormorillonite, <40% sanidine, <12% albite, <10% vermiculite, and/or <10% fluorite.

3. The method according to claim 1, wherein with two stages of leaching the calcined ore with additive into water and collecting the lithium liquor filtrate, produces yields between 50 and 85% lithium extraction from rock to liquor.

4. The method according to claim 1, wherein the pre-pulverization of the ore and dry mixing with sodium sulphate is before roasting.
